(19) United States
(12) Patent Application Publication
(10) Pub. No.: US 2012/0030631 A1
(43) Pub. Date: Feb. 2, 2012

(54) TREE CONTROL WITH ENHANCED HIERARCHY VISIBILITY

(75) Inventor: Carlos Gonzalez, Coconut Creek, FL (US)

(73) Assignee: INTERNATIONAL COMPUTER CONSULTING ORGANIZATION, INC., Coral Springs, FL (US)

(21) Appl. No.: 12/844,183

(22) Filed: Jul. 27, 2010

(51) Int. Cl. G06F 3/048

(52) U.S. Cl. 715/854

(57) ABSTRACT

A hierarchical display system is described herein that provides an indication of a node's hierarchical position in a tree of nodes regardless of a user's present viewing position within a tree control or similar user interface control. Rather than displaying only the currently visible nodes closest to a particular active node, the system may display one or more parent/ancestor nodes in place of the farthest visible nodes. This allows the user to visually recognize a hierarchical path of the active node without scrolling to find the parent or other ancestor nodes. As the user scrolls, the system updates the display to keep one or more ancestor nodes displayed in addition to the nodes coming into view due to the scrolling. Thus, the hierarchical display system provides a more informative and less confusing control for viewing large amounts of hierarchically complex data.

### BACKGROUND

Computer applications are windows into vast amounts of information. Computer users use applications more and more of as a way of accessing information content. Information may include documents, database objects, songs, videos, files, and many other representations of real and virtual objects. A database application, for example, may display to a user each of the tables in a database, and each record in each table. The tables and/or records may number into the thousands or millions, depending on the type of data that the database represents. Users often have content libraries that include, for example, thousands of songs (e.g., MP3 files or videos), photos, or other data.

Tree controls are one common user interface control for displaying hierarchical information to computer users. A tree control generally displays a folder or other icon at a root level, with icons representing child nodes displayed indented below the root level. Child nodes may have children for as many levels as the depth of the data allows. A tree control provides organization and structure so that large amounts of data can be broken down into categories and subcategories that are relevant for the particular data type. For example, a music library might show artists as child nodes of the root level, albums as child nodes of artist nodes, and songs as child nodes of albums. Tree controls are used in file system applications, database applications, media applications, and many other types of applications. Tree controls are often built into an operating system, so that applications can access a common control provides by the operating system, although custom tree controls are also available.

Sometimes even today's tree controls are not up to the task of organizing large amounts of data. For example, when a tree has many nodes at the same level or many branches of nodes with similar names, the value of the tree control for separating data and presenting the user with more easily consumable chunks diminishes. Tree controls often include scroll bars that allow the user to view branches of the tree that are too extensive to fit on a single screen. Once a user has scrolled below the top of the tree, the user can become bewildered by the vast number of nodes and may become disoriented with respect to where the nodes fit into the larger hierarchy managed by the tree control. It is often important to know which sub-tree a user is in, but discovering this information may involve scrolling many screens worth above or below the user's current position in the tree. For example, a user may want to apply an operation to data represented by a tree node, such as deleting a file or modifying database data. To do so, it may be important that the user confirm which node the user is acting upon, and to do that the user may have to know where in the tree the node is situated. Scrolling around in the tree to discover and confirm this information can consume a significant part of the user's time spent viewing the data in the application.

### BRIEF DESCRIPTION OF THE DRAWINGS

FIG. 1 is a block diagram that illustrates components of the hierarchical display system, in one embodiment.

FIG. 2 is a flow diagram that illustrates processing of the hierarchical display system to compress nodes while scrolling, in one embodiment.

FIG. 3 is a flow diagram that illustrates processing of the hierarchical display system to expand nodes while scrolling, in one embodiment.

FIG. 4 is a display diagram that illustrates a user interface produced by the hierarchical display system, in one embodiment.

FIG. 5 is a display diagram that illustrates the user interface of FIG. 4 after a user has scrolled down and with node compression turned off, in one embodiment.

FIG. 6 is a display diagram that illustrates the user interface of FIG. 4 after a user has scrolled down and with node compression turned on, in one embodiment.

### DETAILED DESCRIPTION

A hierarchical display system is described herein that provides an indication of a node's hierarchical position in a tree of nodes regardless of a user's present viewing position within a tree control or similar user interface control. For example, rather than displaying only the currently visible nodes closest to a particular active node, the system may display one or more parent/ancestor nodes in place of the farthest visible nodes. This allows the user to visually recognize a hierarchical path of the active node without scrolling to find the parent or other ancestor nodes. As the user scrolls, the system updates the display to keep one or more ancestor nodes displayed in addition to the nodes coming into view due to the scrolling. In some embodiments, the system displays an ellipsis or other indication to alert the user that one or more nodes are omitted from the display in order to make room for showing one or more ancestor nodes. This allows the user to identify where in the tree hierarchy the user currently is from any particular scrolling position, and which nodes are ancestors of one or more of the visible nodes. The method is reversed as the user scrolls up through the tree, so that intervening nodes (those nodes between the visible nodes and their ancestors) are again displayed. If the number of ancestors is larger than the total tree control height allows, then the system may limit displayed ancestors to a number that can fit on top or in another position while still allowing child nodes to be scrolled and viewed as described further herein. Thus, the hierarchical display system provides a more informative and less confusing control for viewing large amounts of hierarchically complex data.

One example environment in which the system provides an enhanced user experience is a database management application. Database vendors typically provide an administrative application for viewing database elements, such as tables, stored procedures, and so forth. For example, Microsoft provides the SQL Server Management Studio with its SQL Server database product. Database management applications typically display a similar set of child folders under each node representing a database. For example, the child folders may include tables, views, stored procedures, security roles, and so forth. Each of these folders may include child folders representing further hierarchical categorization. When managing more than one database and scrolled even one page away from the root of the hierarchy, it can become quite challenging for an administrator to identify the hierarchical path to a particular node. For example, if an administrator is viewing a “tables” node, it may be difficult to determine the database to which database the “tables” node belongs. This makes any actions related to the node more difficult. For example, if the administrator wants to delete a particular node related to a particular database, it can be challenging for the administrator to find the appropriate node and confirm that the user has identified a node of the correct database. With the hierarchical display system, the ancestry of any currently displayed node is also displayed or is readily ascertained, so that the administrator can perform actions within the tree faster and with confidence that the administrator is acting upon the intended node.

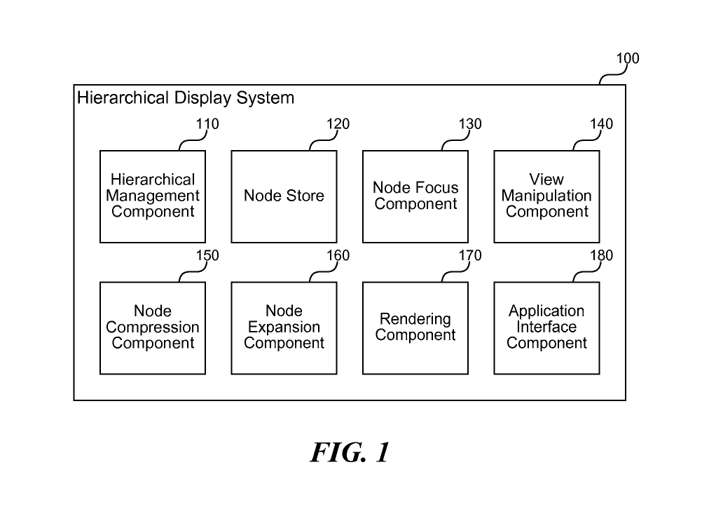

FIG. 1 is a block diagram that illustrates components of the hierarchical display system, in one embodiment. The system 100 includes a hierarchy management component 110, a node store 120, a node focus component 130, a view manipulation component 140, a node compression component 150, a node expansion component 160, a rendering component 170, and an application interface component 180. Each of these components is described in further detail herein.

The hierarchy management component 110 manages a hierarchy of nodes based on one or more relationships related to a particular application domain. The component 110 stores nodes in the node store 120 with information about relationships between nodes (e.g., parent, child, sibling, and so forth). The hierarchy management component 110 may receive a hierarchy description from an application during creation or initialization of a tree or other control implementing the system 100. The hierarchy management component 110 also receives updates to the hierarchy that occur during an application session, such as additions to and deletions from the hierarchy based on user or other actions. In a model-view-controller type of architecture, the hierarchy management component 110 manages the data model used by the rest of the system 100.

The node store 120 is a data store that stores nodes and node relationships. The data store may include one or more memory units, files, file systems, databases, cloud-based storage services, or any other type of storage accessible to application code that implements the system 100. The node store 120 may provide volatile or persistent storage for node information, so that the information is accessible to one or more applications that invoke the system 100 to render hierarchical data.

The node focus component 130 maintains an indication that specifies one or more nodes that are currently in focus within the hierarchy of nodes. The indication may include a single node or range of nodes that are currently in view, and thus are defined to have the current focus. The node or nodes in focus may include the bottom-most node in a displayed tree window or other indication of a node to remain visible to the user, such as a node selected by the user or nodes at the center of a displayed tree window.

The view manipulation component 140 receives one or more commands from a user to modify a displayed view of the hierarchy of nodes. For example, the view manipulation component 140 may receive messages or other indications as the user scrolls a view of the hierarchy up, down, or in other directions or as the user changes the view size (e.g., by expanding or contracting a window containing the view). Upon receiving a view modification command, the view manipulation component determines a new view of the hierarchy to be displayed, and invokes other components of the system 100 to produce the view. For example, the component 140 may provide information about the view to the node focus component 130 to determine whether one or more nodes in focus have changed, to the node compression component 150 to determine whether to hide intervening nodes to allow one or more ancestor nodes to be displayed, and/or to the node expansion component 160 to determine whether nodes that were previously hidden will be displayed again. Finally, the view manipulation component 140 may invoke the rendering component 170 to display the new view.

The node compression component 150 determines one or more nodes of the node hierarchy to hide to allow the view to display one or more ancestor nodes of a node in focus. For example, if a node in focus has hundreds of sibling nodes and the view includes room for only tens of nodes, then the component 150 may hide some siblings of the node in focus to make room to display a parent and potentially other ancestors of the node in focus. In some embodiments, the component 150 uses one or more selection criteria to determine which nodes to hide. For example, the component 150 may select nodes to hide based on the nodes' distance from the node or nodes in focus. The component 150 may hide sibling nodes farthest from the node in focus, since nodes closer to the node in focus may provide the user with helpful context information.

The component 150 may also move up the tree and perform similar processing at other levels. For example, even after compressing siblings of the node in focus, the component 150 may determine that one or more ancestors to be displayed are still not within the view. Thus, the component 150 may compress nodes at multiple levels, such as by hiding siblings of a parent node, until a determined number of levels of the hierarchy are visible within the available view area. As another example of selection criteria, the system may use the hierarchy depth of the node in focus as a threshold for determining display behavior. For example, if the hierarchy is deeper than a configured or determined threshold (e.g., 10 levels), then the system may opt not to display every ancestor of the node in focus as there may not be room within the view to display each of the ancestors and relevant child nodes.

In some embodiments, the node compression component 150 provides an indication of areas that contain compressed (i.e., hidden) nodes, so that the rendering component 170 can provide a visual identifier that alerts the user that some nodes are not currently visible. For example, the rendering component 170 may display an ellipsis, vertical dots, or other visual indication to mark areas where more nodes can be displayed as the user changes the view (e.g., by scrolling or expanding the window).

The node expansion component 160 determines one or more hidden nodes of the node hierarchy to display in response to one or more view modification commands. For example, as the user scrolls within a tree control implementing the system 100, nodes there may be additional room within the displayed view to display nodes that were previously hidden by the node compression component 150. The node compression component 150 and node expansion component 160 work in concert as the user modifies the view to dynamically hide and un-hide nodes as determined by the current view position, node focus, and any provided selection criteria.

The rendering component 170 renders a displayed representation of a current view. The current view is defined by the view size (e.g., window height and width), the size of displayed nodes, a current scroll or other view position, node or nodes in focus (e.g., based on user selection or scroll position), and any other relevant view configuration parameters (e.g., one or more thresholds that modify the selection criteria for hiding and un-hiding nodes). The rendering component 170 may display the view to a computer display or other viewing hardware. Those of ordinary skill in the art will also recognize that in some cases rendering location may be geographically separated from a processing location, such as in the case of using computer remoting applications (e.g., Microsoft Remote Desktop or VNC). The rendering component 170 described herein may operate remotely in such cases or provide a rendered image of the tree view for display at a remote location.

The application interface component 180 provides a programmatic interface through which one or more applications coordinate with the tree control. For example, the application interface component 180 may provide a Microsoft Win32 application programming interface (API), component object model (COM) interface, Microsoft .NET interface, or any other common application communication interface accessible to one or more programming languages available for authoring applications. The system 100 may be provided as a separate module (e.g., a dynamically linked library (DLL)), as a linked static library, or in other forms commonly used for sharing and reusing software code among applications. In some embodiments, the system 100 may be implemented within an operating system and the operating system may expose one or more interfaces for applications to invoke and interact with the system. The application provides the data that is to be rendered in a tree view using the application interface component 180, and the system 100 creates and maintains an appropriate tree view based on the data.

The computing device on which the hierarchical display system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

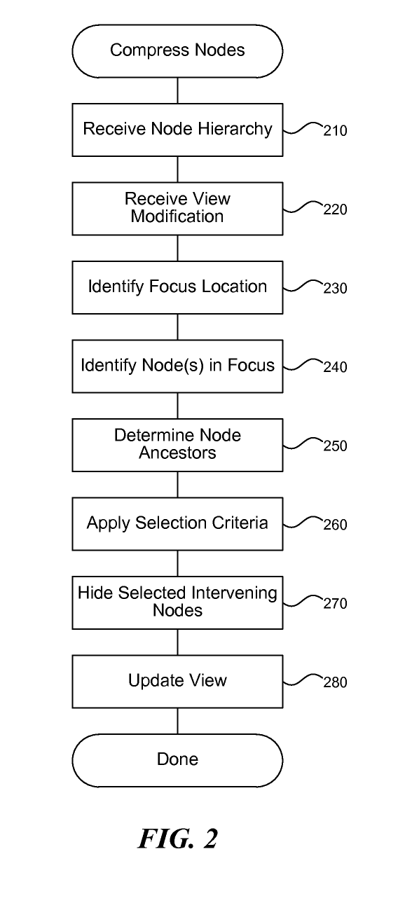

FIG. 2 is a flow diagram that illustrates processing of the hierarchical display system to compress nodes while scrolling, in one embodiment. Beginning in block 210, the system receives a node hierarchy that identifies multiple nodes and one or more relationships between the nodes. The node hierarchy may represent many types of data and problem domains. For example, the nodes might include songs in a music library, database objects in a database application, employees in an organizational chart of a company, and so forth. The system receives the node hierarchy from an application that invokes the system to display a representation of the data.

Continuing in block 220, the system receives a view modification command from an application, wherein the command changes one or more parameters of a previously rendered view of the node hierarchy. The command may include an initial display command upon initial display of a tree view of the received node hierarchy, a scrolling command, a command that changes the view size, and so forth. The system updates an internal representation of the view based on the modified view parameters.

Continuing in block 230, the system identifies a focus location that defines one or more nodes in focus within the view. For example, the system may identify the bottom-most node in the view or nodes within a particular distance of the center of the view as being with the focus location. Continuing in block 240, the system identifies one or more nodes within the focus location as nodes in focus. These nodes are the nodes that determine which ancestors are relevant for displaying in the view. A node in focus may also be determined based on a user selection or other user action that indicates a node that the user is more interested in than other nodes at a particular time.

Continuing in block 250, the system determines one or more ancestor nodes of the nodes in focus. Ancestor nodes may include the immediate parent of a node in focus as well as parents of the parent node, going back all the way to a root node or to a threshold depth determined by the system or configured by the user or application. For example, the system may attempt to display up to four ancestors of nodes in focus. Continuing in block 260, the system applies one or more selection criteria to determine which of the determined ancestor nodes to display in the view. The selection criteria may include any number of criteria applied individually or in combination to determine which ancestor nodes and nodes between the ancestor nodes and nodes in focus (i.e., intervening nodes) to display. For example, the criteria may be based on the view size, total depth of available ancestors, currently selected node, and so forth. As an example, in a particular embodiment, the system may attempt to display the currently selected node, up to four ancestor nodes, and then as many intervening nodes as will fit within the view size.

Continuing in block 270, the system hides intervening nodes that will not fit in the view area after determining the ancestor nodes that will be displayed in the view with the nodes in focus. The system may process the entire view, flagging nodes that will be visible and nodes that will be hidden, and then update the view in one operation for better performance. The system may determine intervening nodes to display based on distance from the node or nodes in focus. For example, the system may prefer to display intervening nodes closest to or farthest from the nodes in focus. In some embodiments, the system allows applications to configure this behavior, so that the application can select behavior most suitable for the application's problem domain.

Continuing in block 280, the system updates the view of the node hierarchy to display the nodes in focus, determined ancestor nodes, and any intervening nodes that are not hidden. After block 280, these steps conclude.

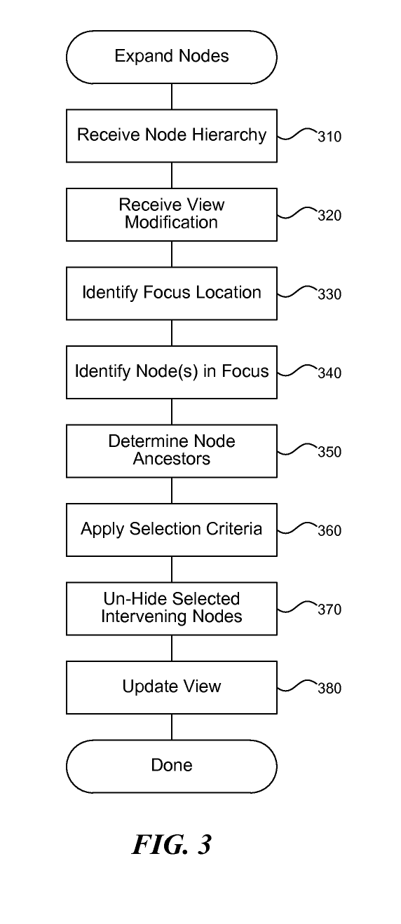

FIG. 3 is a flow diagram that illustrates processing of the hierarchical display system to expand nodes while scrolling, in one embodiment. Beginning in block 310, the system receives a node hierarchy that identifies multiple nodes and one or more relationships between the nodes. The node hierarchy may represent many types of data and problem domains. For example, the nodes might include songs in a music library, database objects in a database application, employees in an organizational chart of a company, and so forth. The system receives the node hierarchy from an application that invokes the system to display a representation of the data. In the case of expanding nodes, the system may operate on a previously received in-memory or other representation of node data.

Continuing in block 320, the system receives a view modification command from an application, wherein the command changes one or more parameters of a previously rendered view of the node hierarchy. The command may include an initial display command upon initial display of a tree view of the received node hierarchy, a scrolling command, a command that changes the view size, and so forth. For example, the user may be scrolling up in the tree after having scrolled somewhere below the root of the tree. The system updates an internal representation of the view based on the modified view parameters.

Continuing in block 330, the system identifies a focus location that defines one or more nodes in focus within the view. For example, the system may identify the bottom-most node in the view or nodes within a particular distance of the center of the view as being with the focus location. As the user scrolls, the focus location may change leading to hiding and un-hiding of one or more nodes. Continuing in block 340, the system identifies one or more nodes within the focus location as nodes in focus. These nodes are the nodes that determine which ancestors are relevant for displaying in the view. A node in focus may also be determined based on a user selection or other user action that indicates a node that the user is more interested in than other nodes at a particular time.

Continuing in block 350, the system determines one or more ancestor nodes of the nodes in focus. Ancestor nodes may include the immediate parent of a node in focus as well as parents of the parent node, going back all the way to a root node or to a threshold depth determined by the system or configured by the user or application. For example, the system may attempt to display up to four ancestors of nodes in focus. Continuing in block 360, the system applies one or more selection criteria to determine which of the determined ancestor nodes and intervening nodes to display in the view. The selection criteria may include any number of criteria applied individually or in combination to determine which ancestor nodes and nodes between the ancestor nodes and nodes in focus (i.e., intervening nodes) to display. For example, the criteria may be based on the view size, total depth of available ancestors, currently selected node, and so forth. As an example, in a particular embodiment, the system may attempt to display the currently selected node, up to four ancestor nodes, and then as many intervening nodes as will fit within the view size.

Continuing in block 370, the system un-hides one or more previously hidden intervening nodes that now fit within the view based on the received view modification. If a user initially scrolled down, the system may have hidden intervening nodes that did not fit to allow the display of a bottom-most node and its ancestors. As the user scrolls back up and the bottom-most node in the view changes, the system can display previously hidden intervening nodes between the bottom-most node and the ancestor nodes. This may occur at several levels, so that nodes are unhidden from a sibling, parent, or ancestor level of the node or nodes in focus. The system may process the entire view, flagging nodes that will be visible and nodes that will be hidden, and then update the view in one operation for better performance.

Continuing in block 380, the system updates the view of the node hierarchy to display the nodes in focus, determined ancestor nodes, and any intervening nodes that are not hidden. After block 380, these steps conclude.

The processes of FIGS. 2 and 3 are complementary and may occur at the same time and in the same software unit. They are shown separately herein for ease of illustration, but those of ordinary skill in the art will recognize that within the same displayed view some nodes may be hidden while other nodes are being unhidden based on changes in the view prompted by user action related to the view (e.g., scrolling, deleting or adding nodes, and so forth).

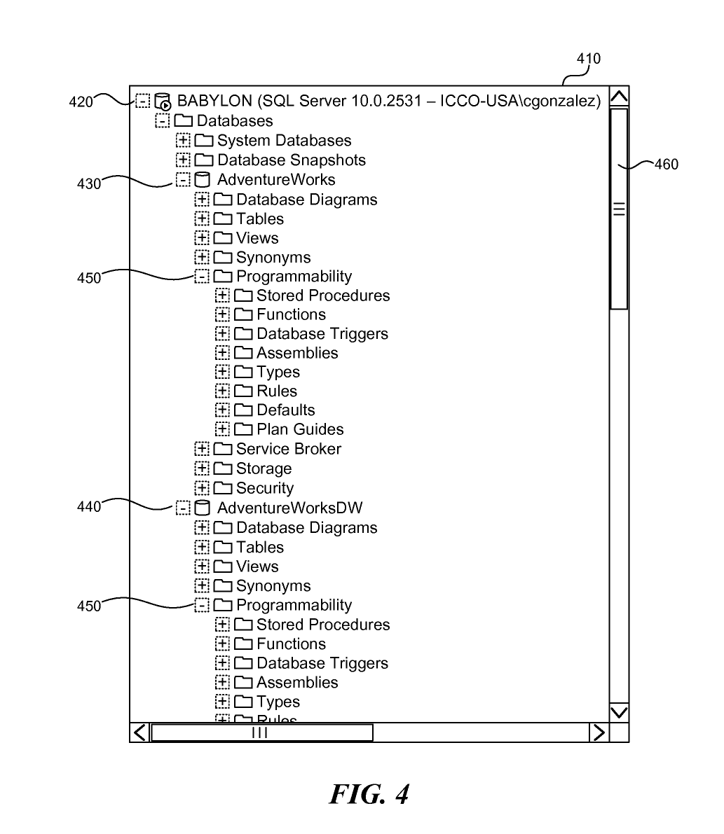

FIG. 4 is a display diagram that illustrates a user interface produced by the hierarchical display system, in one embodiment. In this example, the application is a database management application. The view 410 shows a server node 420 at the root that includes a first database node 430 and a second database node 440. Each database node has similar child nodes 450 that organize objects associated with each database. The view 410 includes a vertical scroll bar 460 because the number of nodes exceeds the viewable area. A scroll bar is just one mechanism that permits navigation, and other mechanisms such as a mouse wheel or keyboard arrows can be used instead to scroll through the view. In the case of the view 410, all of the ancestor nodes of each visible node are also visible, because the scroll bar 460 is currently at the top.

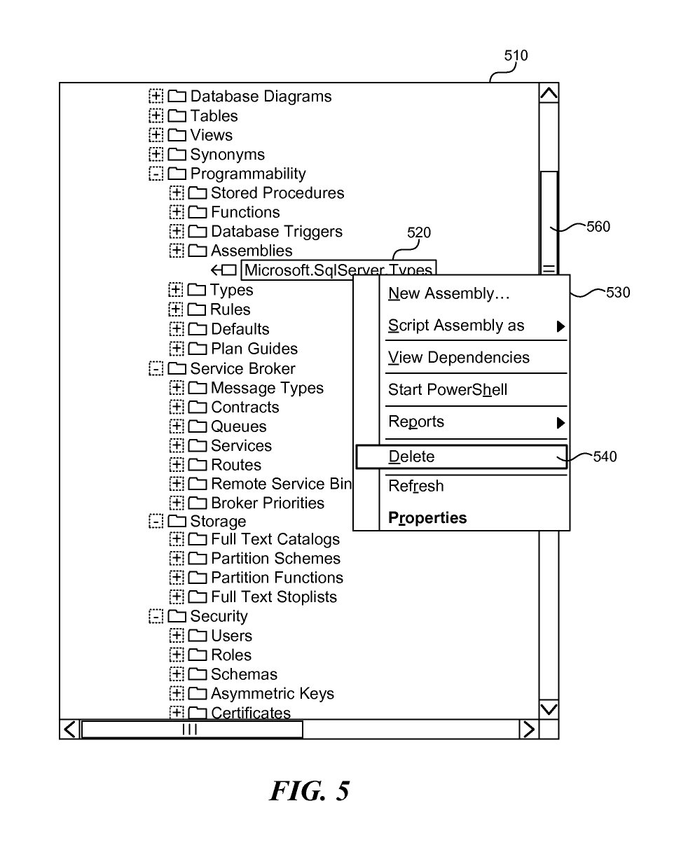

FIG. 5 is a display diagram that illustrates the user interface of FIG. 4 after a user has scrolled down and with node compression turned off, in one embodiment. The view 510 shows the result after the user has scrolled down from the initial view of FIG. 4, as indicated by the scroll bar 560. The user has selected a particular child node 520 on which to perform an operation. The user has invoked a context menu 530 associated with the node 520 (e.g., by right clicking a mouse), and is selecting a delete operation 540. Unfortunately, it is ambiguous from which database the user will be deleting the node 520. The ancestor node that displays the database name has scrolled out of view, and the user cannot determine which database the user's action will affect without scrolling back up to the top of the node hierarchy. In a conventional tree control, as a user navigates vertically down the hierarchy of the folder tree structure, the root node is no longer visible, and then other nodes below go out of view from the top as the user continues scrolling down the control.

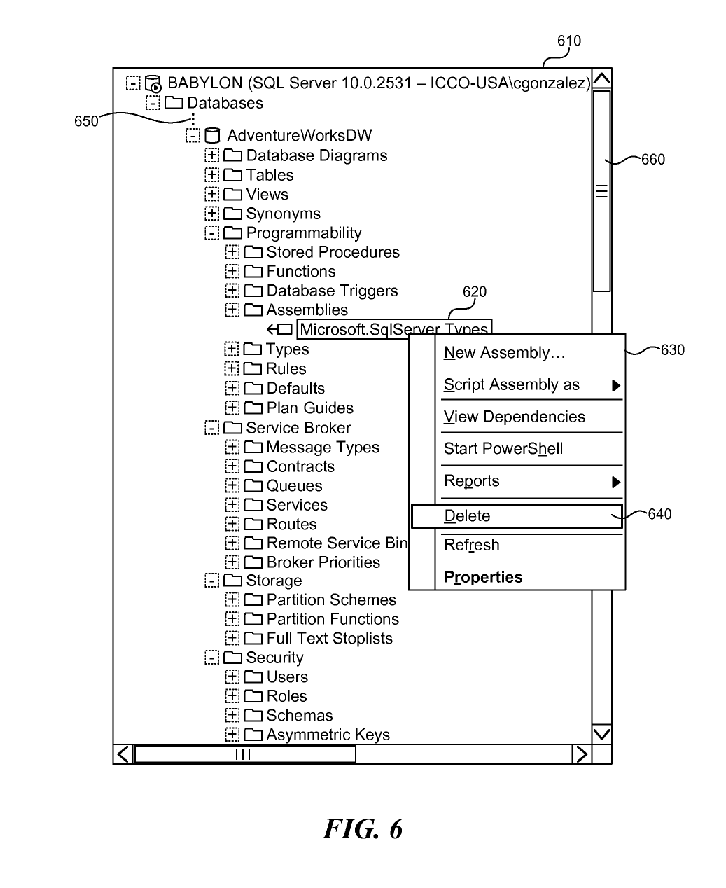

FIG. 6 is a display diagram that illustrates the user interface of FIG. 4 after a user has scrolled down and with node compression turned on, in one embodiment. The view 610 shows the result after the user has scrolled down from the initial view of FIG. 4, as indicated by the scroll bar 660. The user has selected a particular child node 620 on which to perform an operation. The user has invoked a context menu 630 associated with the node 620 (e.g., by right clicking a mouse), and is selecting a delete operation 640. The system has compressed some nodes, as visually indicated by the graphical indication 650. The system has hidden nodes between the “Databases” node and the “AdventureWorksDW” node to allow the user to see the current database. Thus, in contrast to the situation illustrated by FIG. 5, the user can now confidently perform the operation on the node 620, knowing which database will be affected. The system has kept the ancestor node that displays the database name in view, so that the user can determine which database the user's action will affect without scrolling back up to the top of the node hierarchy.

Upon scrolling back up, the process illustrated by FIGS. 4 and 6 reverses itself, un-hiding nodes that will fit within the view. Upon scrolling completely to the top of the tree, the control again looks like that shown in FIG. 4.

In some embodiments, if the number of ancestor nodes is such that they cannot all fit in the viewable area in addition to the scrollable child nodes, the hierarchical display system automatically limits the number of displayed ancestor nodes according to one or more selection criteria. This limit can be performed in various ways. For example, the system may determine the number of displayed ancestor nodes based on a percentage of the control's overall height (e.g., 50%), the height limit can be a fixed number (e.g., 4 ancestors or 100 pixels), and so forth. If the number of ancestor nodes exceeds the stack limits, there are several options to deal with how to display the ancestor nodes within that limit. For example, the system may skip showing one or more rows at the top, middle, or bottom of the stack, skip showing one or more rows in the middle of the stack and show an indicator that not all ancestor nodes are being shown, visually compress the rows in the middle of the stack (so they become shorter), combine multiple ancestors onto one line/row (e.g., placing dashes or other symbols between them), and so on. Those skilled in the art will recognize other creative ways of dealing with the height limitation and available viewable area.

In some embodiments, the hierarchical display system replaces or inherits from an operating system common control. Microsoft Windows and other operating systems and/or programming environments (like .NET and Sun Java) provide common controls for use by applications. These common controls often include at least one tree control. In many cases, applications can use the tree control described herein without modifying the application, and thus the operating system or programming environment may allow a traditional tree control to be replaced by one implementing the hierarchical display system described herein. This allows existing applications to benefit from the increased usability of the system without updating the applications.

In some embodiments, the system may operate as a layer between a traditional tree control and an application. The system can use a traditional tree control by dynamically swapping nodes into and out of the traditional tree to simulate the behavior of keeping certain ancestor nodes visible. This allows an application to leverage the functionality of the system within the context of existing available common controls.

In some embodiments, the hierarchical display system is used in non-traditional computing environments. For example, the system may be applied to the limited display space available in mobile devices (e.g., smartphones and MP3 players), dedicated hardware displays (e.g., consumer electronics with a LCD status screen), and so forth. The system described herein can be implemented in hardware or software and in a variety of form factors and device types.

In some embodiments, the hierarchical display system provides one or more configuration settings that an application or user can modify to alter behavior of the system. For example, the system may allow configuration of thresholds described herein. For some applications particular nodes may be important than others, and the system may allow the application to flag such nodes so that they are continuously displayed when they would normally scroll out of view in a traditional tree control. The system may use this information to hide non-flagged ancestors and keep flagged ancestors visible. For example, in a database application the database node is typically a more informative indicator than its parent or immediate children, and thus may be more useful for an application to keep in view.

From the foregoing, it will be appreciated that specific embodiments of the hierarchical display system have been described herein for purposes of illustration, but that various modifications may be made without deviating from the spirit and scope of the invention. Accordingly, the invention is not limited except as by the appended claims.

I/We claim:

1. A computer-implemented method for compressing nodes in a hierarchical display to keep ancestor nodes visible, the method comprising:
receiving a node hierarchy that identifies multiple nodes and one or more relationships between the nodes;
receiving a view modification command from an application, wherein the command changes one or more parameters of a previously rendered view of the node hierarchy;
identifying a focus location that defines one or more nodes in focus within the rendered view;
identifying one or more nodes within the focus location as nodes in focus;
determining one or more ancestor nodes of the nodes in focus;
applying one or more selection criteria to determine which of the determined ancestor nodes to display in the view;
hiding intervening nodes that will not fit in the view area after determining the ancestor nodes that will be displayed in the view with the nodes in focus; and
updating the view of the node hierarchy to display the nodes in focus, determined ancestor nodes, and any intervening nodes that are not hidden,
wherein the preceding steps are performed by at least one processor.

2. The method of claim 1 wherein receiving the node hierarchy comprises receiving the node hierarchy from an application that invoked the method.

3. The method of claim 1 wherein receiving the view modification command comprises receiving an initial display command upon initial display of a tree view of the received node hierarchy.

4. The method of claim 1 wherein receiving the view modification command comprises receiving a scrolling command to scroll the view and updating an internal representation of the view based on one or more modified view parameters based on the scrolling command.

5. The method of claim 1 wherein identifying the focus location comprises identifying a bottom-most node in the view as being with the focus location.

6. The method of claim 1 wherein identifying nodes in focus comprises determining a node in focus based on a user selection that indicates a node that the user is more interested in than other nodes at a particular time.

7. The method of claim 1 wherein determining ancestor nodes comprises identifying an immediate parent of a node in focus and parents of the parent node.

8. The method of claim 1 wherein determining ancestor nodes comprises ancestor nodes up to a threshold depth.

9. The method of claim 1 wherein applying selecting criteria comprises applying one or more criteria based on the view size and total depth of available ancestors.

10. The method of claim 1 wherein hiding intervening nodes comprises determining intervening nodes to display based on distance from the nodes in focus.

11. A computer system for displaying hierarchical data, the system comprising:
a processor and memory configured to execute software instructions embodied in the following components;
a hierarchy management component configured to manage a hierarchy of nodes based on one or more relationships associated with a particular application domain;
a node store configured to stores nodes and node relationships;
a node focus component configured to maintain an indication that specifies one or more nodes that are currently in focus within the hierarchy of nodes;
a view manipulation component configured to receive one or more commands from a user to modify a displayed view of the hierarchy of nodes;
a node compression component configured to determine one or more nodes of the node hierarchy to hide to allow the view to display one or more ancestor nodes of a node in focus; and
a rendering component configured to render a displayed representation of a current view.

12. The system of claim 11 wherein the hierarchy management component is further configured to receive a hierarchy description from an application during initialization of a tree control and to receive updates to the hierarchy that occur during an application session based on user actions.

13. The system of claim 11 wherein the node focus component is further configured to identify a single node or range of nodes that are currently in view that have the current focus.

14. The system of claim 11 wherein the view manipulation component is further configured to receive messages as the user scrolls a view of the hierarchy up or down or as the user changes the view size.

15. The system of claim 11 wherein the view manipulation component is further configured to, upon receiving a view modification command, determine a new view of the hierarchy to be displayed and invoke the node focus component to determine whether one or more nodes in focus have changed, the node compression component to determine whether to hide intervening nodes to allow one or more ancestor nodes to be displayed, and the node expansion component to determine whether nodes that were previously hidden can be displayed again.

16. The system of claim 11 wherein the node compression component is further configured to hide at least one sibling of the node in focus to make room to display an ancestor node of the node in focus.

17. The system of claim 11 wherein the node compression component is further configured to apply one or more selection criteria to determine which nodes to hide.

18. The system of claim 11 wherein the node compression component is further configured to identify nodes to hide at multiple levels of the hierarchy from the node in focus.

19. The system of claim 11 wherein the node compression component is further configured to provide a visual indication of areas that contain compressed nodes.

20. A computer-readable storage medium comprising instructions for controlling a computer system to redisplay previously hidden nodes in a hierarchical display, wherein the instructions, upon execution, cause a processor to perform actions comprising:
receiving a node hierarchy that identifies multiple nodes and one or more relationships between the nodes;
receiving a view modification command from an application, wherein the command changes one or more parameters of a previously rendered view of the node hierarchy;
identifying a focus location that defines one or more nodes in focus within the rendered view;
identifying one or more nodes within the focus location as nodes in focus;
determining one or more ancestor nodes of the nodes in focus;
applying one or more selection criteria to determine which of the determined ancestor nodes to display in the view;
un-hiding one or more previously hidden intervening nodes that now fit within the view based on the received view modification; and
updating the view of the node hierarchy to display the nodes in focus, determined ancestor nodes, and any intervening nodes that are not hidden.
